(19) United States
(12) Patent Application Publication
(10) Pub. No.: US 2023/0212363 A1
(43) Pub. Date: Jul. 6, 2023

(54) PACKAGING FILMS WITH ANTI-FOGGING AGENT

(71) Applicant: NOVAMONT S.P.A., Novara (IT)

(72) Inventors: Mariangela AIANI, Novara (IT); Catia BASTIOLI, Novara (IT); Paola COMAZZI, Marano Ticino (NO) (IT); Sebastià GESTI GARCIA, Torino (IT); Tiziana MILIZIA, Novara (IT); Claudio RUSSO, Novara (IT)

(21) Appl. No.: 18/002,269

(22) PCT Filed: Jun. 23, 2021
(86) PCT No.: PCT/EP2021/067193

§ 371 Date: Dec. 18, 2022

(30) Foreign Application Priority Data
Jun. 23, 2020 (IT) 102020000015022

(51) Int. Cl. C08J 5/18; C08L 67/02

(52) U.S. Cl. CPC C08J 5/18; C08L 67/02; C08J 2367/02

(57) ABSTRACT

Packaging film with a coefficient of static friction >5 comprising:
(i) a biodegradable polyester with a melt strength of 0.7-4 g and comprising units of at least one dicarboxylic acid and at least one diol, and
(ii) an anti-fogging agent selected from the esters of a polyfunctional alcohol, provided that the ester is not a stearate.

The present invention relates to a biodegradable packaging film comprising a biodegradable polyester and an anti-fogging agent.

Packaging films are known from trade and the literature. Typically, these films are between 3 and 50 μm thick and are used, for example, for packaging food products before the products are placed in a refrigerator or packed in containers.

The optimal packaging film is not easy to achieve because a number of special technical characteristics are required for its use, such as:
Clingability

The property of a film to adhere both to itself and to other non-adherent surfaces, without the addition of an adhesive, is fundamental. This property allows the user of such films to wrap one or more layers of film around an object (e.g. food on a plate) and in this way seal it hermetically.
Transparency

An essential feature is transparency, which allows the user of such films to identify an object that is wrapped in it without the need to unwrap the object. From a commercial point of view, it is highly desirable that the product wrapped in the film should be as clearly visible as possible and it is therefore particularly important that there is no dulling of the film over time.
Mechanical properties

Mechanical properties are the physical properties that impart mechanical performance and strength to the packaging material. In particular, tensile strength (MPa), elongation at break (%) and modulus of elasticity (MPa) in both machine direction (MD) and transverse direction (TD) are measured.
Shelf life

It is essential that polyesters that give the film good ageing stability be used to ensure that the products will hold for as long as possible, and in any case at least up to six months, preferably a year.
Unwinding

The ability to adhere is important, but if it is excessive it can lead to difficulty in unwinding the film, both industrially and in use of the finished product, and possible film breakage during packaging. Ease of unwinding is a decisive property for use in industrial packaging machines.
Antifogging

The property of anti-fogging is a feature that is particularly appreciated by the market. It avoids the micro-condensation of moisture that dulls the packaging of fresh and chilled products, usually meat and vegetable products.
Film suitability for packaging machines

The film must fulfil the right requirements to allow the production of thin elastic films for use in automatic packaging machines (wrapping machines). For this application the “smoothness” of the film on moving parts is particularly critical and requires special set-up operations to improve the performance of the film in the packaging machine.

There is therefore a particular need for films made from biodegradable polyesters that optimise the properties described above.

The use of antifogging for polymer films is widely known in the art.

WO2019012564A1 describes a plasticised PVC stretch film containing ester-based plasticisers, polyesters and natural oils, of renewable origin, and the film additionally comprises anti-fogging agents, typically fatty acid esters. WO2019012564A1 points out a technical disadvantage according to which biodegradable polyester films with antifogging do not ensure the special features and right requirements for making thin resilient films for use on automatic packaging machines (wrapping machines); for this application the “viscosity” of the film on moving parts is particularly critical and is such as to require special set-up operations which necessarily unacceptably compromise the performance of the film in the packaging machine. EP2550330A1 describes a polymer blend, a clingfilm and the process for obtaining it. Specifically, it is a film comprising an aliphatic polyester with a low aromatic content.

EP2499189B1 describes a process for producing a multilayer film comprising 45-70% by weight of an aliphatic-aromatic polyester, 30-55% by weight of PLA with a blow-up ratio of less than or equal to 4:1, and in which at least the core layer comprises 20-70% w/w of an aliphatic-aromatic polyester, 30-80% by weight of PLA.

EP2331634B1 discloses a biodegradable polymer mixture comprising 40-95% by weight of aliphatic or aliphatic-aromatic polyester, 5-60% by weight of polyalkylene carbonate, in particular polypropylene carbonate, and 0.1-5% by weight of a copolymer containing an epoxy group based on styrene, acrylic acid ester and/or methacrylic acid ester based on the sum of the two preceding components. The possibility of using anti-fogging agents is described in all these patents.

In Patents IT102020000012184 and EP2632970 the Applicant has described biodegradable polyesters which are particularly suitable for use in the manufacture of films comprising units derived from at least one diacid and at least one diol, characterised by a coefficient of static friction of more than 5 and more than 10, respectively.

Surprisingly, it has been found that when the biodegradable polyesters used for the production of films with a static friction coefficient of more than 5 and preferably more than 10 mentioned above have added anti-fogging agents, a synergistic effect is obtained that endows these films with not only the well-known improved anti-fogging capacity, but also a better unwinding capacity, sometimes even an increase in transparency characteristics, while maintaining mechanical properties and ageing stability substantially unchanged. Surprisingly, these films are also able to be optimally suited to food tray packaging machines.

The use of an anti-fogging agent in a film made from a biodegradable polyester is neither easy nor obvious because the anti-fogging agent is not necessarily compatible with the polyester itself. In many cases the anti-fogging agent may simply not provide the desired anti-fogging function, while in other cases it may result in the formation of a powder on the surface of the film that makes the film dull, not very transparent and with decreased capacity for desired clingability. Furthermore, there are technical prejudices in the art in that it is claimed that a film produced with a biodegradable polyester including an anti-fogging agent could be prejudicial to its use on industrial packaging machines, making its use economically unprofitable.

It is therefore particularly desirable to find specific anti-fogging agents for films made from biodegradable aliphatic and aliphatic-aromatic polyesters. Suitable anti-fogging agents have therefore been selected to solve the technical problems described above.

It is therefore one aspect according to the present invention to provide a packaging film of 3-50 μm, preferably 6-25 μm, having a coefficient of static friction (COF) >5, preferably >10 comprising:

(i) a biodegradable polyester having a melt strength of 0.7-4 g and comprising units of at least one dicarboxylic acid and at least one diol and having:
Mn≥40000
Mw/q≤90000,

where melt strength is measured according to ISO 16790:2005 at 180° C. and γ=103.7 s⁻¹ using a capillary of 1 mm diameter and L/D=30 at a constant acceleration of 6 mm/sec² and a stretching length of 110 mm; the molecular weights “Mn” and “Mw” are measured by gel permeation chromatography (GPC); “q”=the percentage by weight of polyester oligomer having a molecular weight ≤10000 measured by GPC; and

(ii) an anti-fogging agent selected from the esters of a polyfunctional alcohol, preferably from the condensation products of a polyfunctional alcohol with a fatty acid with the proviso that said ester is not a stearate and where said anti-fogging agent is present in amounts of 0.2-5%, preferably 1-3%, relative to the polyester content. More preferably said anti-fogging agent is present in amounts of 1.0-2.0%, even more preferably in amounts of 1.0-1.5%.

For what concerns ISO 16790:2005, according to said standard, the value of melt strength is expressed in Newton. In the text and in the examples, however, for ease of reading, the values of are expressed as “gram-strength” according the following conversion: 1N=102 g-strength; 1 cN=1.02 g-strength. For this reason, the data obtained in Newton are converted into gram-strength by multiplying the values by 0.0098.

The anti-fogging agents according to the present invention are selected from the esters of a polyfunctional alcohol, preferably from the condensation products of a polyfunctional alcohol with one or more fatty acids and their ethoxylated derivatives, with the proviso that said ester is not an ester of stearic acid. Hence, suitable compounds which may be used as anti-fogging agents are polyglyceryl laurate, sorbitan monooleate, sorbitan trioleate, glycerine monopalmitate and sorbitan polyoxyethylene monolaurate ester.

In a preferred aspect of the invention the anti-fogging agent is selected from an ester of a fatty acid having 8 to 18 carbon atoms, more preferably 12 to 16 carbon atoms. In a particularly preferred aspect of the invention the fatty acid ester is selected from polyglyceryl laurate and sorbitan monolaurate.

In the present invention, with respect to anti-fogging agents, “esters” means either pure esters or mixtures of esters with two or more individual esters differing from each other.

The ester distinguishing the antifogging agents according to the present invention comprises at least 20% by weight of a partial ester of the polyfunctional alcohol, preferably 30% by weight and even more preferably 60% by weight of the ester itself. In some cases, the partial ester of the polyfunctional alcohol or condensation product of a polyfunctional alcohol with a fatty acid has been found to be up to 80% or 90% by weight in relation to the ester.

Said anti-fogging agents can be added to the polyester either by an extrusion process directly into the desired final concentration, or in a hopper during the film-forming step in the form of a “masterbatch”. A “masterbatch” in the present invention means a polyester pellet with a high concentration of the anti-fogging agent. The concentration of the additive in the masterbatch is usually 10%.

Preferably, the film anti-fogging agent according to the present invention is biodegradable according to the criteria provided in standard EN13432. More preferably, the antifogging agent undergoes 10 to 60% biodegradation in a time window of 10 days within 28 days of testing according to OECD method 301B.

The polyesters that can be used to produce the films according to the invention are those in the aforementioned patents in the name of the Applicant, IT102020000012184 and EP 2632970, to which reference is made for the characteristics of the polyesters and the method of preparation. As far as the coefficient of static friction (COF) is concerned, it expresses the resistance of a material to slip. With respect to film, the static coefficient of friction is determined according to a modification of ASTM standard D1894 “Static and kinetic coefficients of friction of plastic films and sheets”. In accordance with the present invention, the static friction coefficient is therefore measured in the manner set forth below.

A sample of film having a thickness of between 3 and 50 μm, preferably between 6 and 25 μm, is wrapped around a glass plate support surface of approximately 150×300 mm×2 mm thick. The film sample must adhere perfectly to the glass plate and must have a smooth wrinkle-free surface. To achieve this condition, a brush may be used to remove any air bubbles that may form between the film and the glass plate by applying moderate pressure. The plate is placed in a horizontal position and a stainless steel sled weighing 200±5 grams and measuring 63.5×5 mm thick is placed upon it. Moderate pressure is manually applied to its surface to improve the adhesion of the sled to the surface of the film. The load cell is connected to one end of the sled by means of a nylon filament. The load cell is positioned on the mobile crossbar of the dynamometer and is able to move at a constant speed of 10 mm/min. The coefficient of static friction is defined as the ratio between the force (F) recorded by the dynamometer at the moment when the sled no longer adheres to the film (tangential friction force which opposes sliding) and the weight force (Fg) which acts perpendicularly on the two contact surfaces (weight force of the steel sled).

Preferably, the polyester used for the preparation of adherent films according to the present invention has a gel fraction of less than 5%, more preferably less than 3%, even more preferably less than 10%. The gel fraction is determined by placing a sample of polyester (X1) in chloroform, then filtering the mixture on a 25-45 μm sieve and measuring the weight of the material remaining on the filtration screen (X2). The gel fraction is determined as the ratio of the material thus obtained to the weight of the sample, i.e. (X2/X1)×100.

The polyester is advantageously selected from biodegradable aliphatic and aliphatic-aromatic polyesters, with aliphatic-aromatic polyesters being particularly preferred.

The aliphatic polyesters are obtained from at least one aliphatic dicarboxylic acid and at least one aliphatic diol.

With regard to the aliphatic-aromatic polyesters, they have an aromatic part mainly constituted by at least one polyfunctional aromatic acid and an aliphatic part comprising at least one aliphatic dicarboxylic acid and at least one aliphatic diol.

Polyfunctional aromatic acids are dicarboxylic aromatic compounds of the phthalic acid type and their esters and heterocyclic dicarboxylic aromatic compounds of renewable origin and their esters. Particularly preferred are 2,5-furandicarboxylic acid and its esters and terephthalic acid and its esters and mixtures thereof.

By aliphatic dicarboxylic acids are meant dicarboxylic acids having between 2 and 22 carbon atoms in the main chain and their esters. Dicarboxylic acids from renewable sources, their esters and mixtures thereof are preferred; of these adipic acid, pimelic acid, suberic acid, sebacic acid, azelaic acid, undecandioic acid, dodecandioic acid, brassylic acid and mixtures thereof are preferred. In a particularly preferred embodiment, the aliphatic dicarboxylic acids of the biodegradable polyester for producing antifogging films according to the present invention comprise at least 50% by moles of azelaic acid, sebacic acid, adipic acid or mixtures thereof with respect to the total moles of aliphatic dicarboxylic acids.

Also included are dicarboxylic acids with unsaturations within the chain such as itaconic and maleic acids.

In the polyester used according to the present invention, diols are understood to be compounds bearing two hydroxyl groups. Aliphatic diols from C2 to C13 are preferred.

Examples of aliphatic diols include: 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecandiol, 1,4-cyclohexanedimethanol, neopentyl glycol, 2-methyl-1,3-propanediol, dianhydrosorbitol, dianhydromannitol, dianhydroiditol, cyclohexanediol, cyclohexanemethanediol and mixtures thereof. Of these, 1,4-butanediol, 1,3-propanediol and 1,2-ethanediol and mixtures thereof are particularly preferred. In a particularly preferred embodiment the diols of the biodegradable polyester comprise at least 50% by moles, preferably at least 80% by moles, of 1,4-butanediol relative to the total moles of diols.

The aliphatic aromatic polyesters are characterised by a polyfunctional aromatic acid content of between 30-70% by moles, preferably between 40-60% by moles in relation to the total content of dicarboxylic acids by moles.

Advantageously, branched compounds may be added to aliphatic and aliphatic-aromatic polyesters in an amount of less than 0.5%, preferably less than 0.2% by moles relative to the total content of dicarboxylic acids by moles. The said branched compounds are selected from the group of polyfunctional molecules such as, for example, polyacids, polyols and mixtures thereof.

Examples of polyacids are: 1,1,2-ethanetricarboxylic acid, 1,1,2,2-ethanetetracarboxylic acid, 1,3,5-pentanetricarboxylic acid, 1,2,3,4-cyclopentanetetracarboxylic acid, malic acid, citric acid, tartaric acid, 3-hydroxyglutaric acid, mucic acid, trihydroxyglutaric acid, hydroxyisophthalic acid, their derivatives and mixtures thereof.

Examples of polyols are: glycerol, hexanetriol, pentaerythritol, sorbitol, trimethylolethane, trimethylolpropane, mannitol, 1,2,4-butanetriol, xylitol, 1,1,4,4-tetrakis(hydroxymethyl) cyclohexane, arabitol, adonitol, iditol and mixtures thereof.

The aliphatic and aliphatic-aromatic polyesters may advantageously contain co-monomers of the hydroxy acid type in percentages not exceeding 30% and preferably not exceeding 20% by moles relative to the total content of dicarboxylic acids by moles. They may be present with either a random or block distribution of the repeating units.

The preferred hydroxy acids are D and L lactic, glycolic, butyric, valeric, hexanoic, heptanoic, octanoic, nonanoic, decanoic, undecanoic, dodecanoic, tridecanoic, tetradecanoic, pentadecanoic, hexadecanoic, heptadecanoic and octadecanoic acids. Preferred are hydroxy acids of the type with 3 or 4 carbon atoms in the main chain.

Films with antifogging agent obtained from mixtures of different polyesters are also included in the invention.

In the meaning according to the present invention, biodegradable polyesters are understood to be polyesters which are biodegradable according to standard EN 13432.

The polyester used to produce antifogging films according to the present invention may be used in a mixture, including such obtained by reactive extrusion processes, with one or more polymers of synthetic or natural origin, whether biodegradable or not.

Preferably this reactive extrusion process is carried out with the addition of peroxides, epoxides or carbodiimides.

Preferably said reactive extrusion process is conducted using peroxides in an amount in the range 0.001-0.2% and preferably 0.01-0.1% by weight relative to the sum of the polymers fed to the reactive extrusion process.

As far as the addition of epoxides is concerned, these are preferably used in quantities of 0.1-2%, more preferably 0.2-1% by weight of the sum of the polymers fed to the reactive extrusion process.

If carbodiimides are used, these are preferably used in quantities of 0.05-2%, more preferably 0.1-1% by weight of the sum of the polymers fed to the reactive extrusion process.

Mixtures of these peroxides, epoxides and carbodiimides may also be used.

Examples of peroxides that may be advantageously used are selected from the group of dialkyl peroxides such as: benzoyl peroxide, lauroyl peroxide, isononanoyl peroxide, di-(t-butylperoxyisopropyl)benzene, t-butyl peroxide, dicumyl peroxide, alpha,alpha′-di(t-butylperoxy)diisopropylbenzene, 2,5-dimethyl-2,5-di(t-butylperoxy)hexane, t-butyl cumyl peroxide, di-t-butyl peroxide, 2,5-dimethyl-2,5-di(t-butylperoxy)hex-3-yne, di(4-t-butylcyclohexyl)peroxy dicarbonate, dicetyl peroxydicarbonate, dimyristyl peroxydicarbonate, 3,6,9-triethyl-3,6,9-trimethyl-1,4,7-triperoxonane, di(2-ethylhexyl) peroxydicarbonate and mixtures thereof.

Examples of epoxides that may advantageously be used are all polyepoxides from epoxidised oils and/or styrene-glycidylether-methyl methacrylate, glycidylether-methyl methacrylate, in a range of molecular weights between 1000 and 10000 and with a number of epoxides per molecule in the range from 1 to 30 and preferably between 5 and 25, and epoxides selected from the group comprising: diethylene glycol diglycidyl ether, polyethylene glycol diglycidyl ether, glycerol polyglycidyl ether, 1,2-epoxybutane, polyglycerol polyglycidyl ether, isoprene diepoxide, and cycloaliphatic diepoxides, 1,4-cyclohexanedimethanol diglycidyl ether, glycidyl 2-methylphenyl ether, glycerol propoxylatotriglycidyl ether, 1,4-butanediol diglycidyl ether, sorbitol polyglycidyl ether, glycerol diglycidyl ether, tetraglycidyl ether of meta-xylenediamine and diglycidyl ether of bisphenol A and mixtures thereof.

Catalysts may also be used to increase the reactivity of the reactive groups. In the case of polyepoxides, for example, salts of fatty acids may be used. Calcium and zinc stearates are particularly preferred.

Examples of carbodiimides that may advantageously be used are selected from the group including: poly(cyclooctylene carbodiimide), poly(1,4-dimethylenecyclohexylene carbodiimide), poly(cyclohexylene carbodiimide), poly(ethylene carbodiimide), poly(butylene carbodiimide), poly(isobutylene carbodiimide), poly(nonylene carbodiimide), poly(dodecylene carbodiimide), poly(neopentylene carbodiimide), poly(1,4-dimethylene phenylene carbodiimide), poly(2,2′,6,6′-tetraisopropyldiphenylene carbodiimide) (Stabaxol® D), poly(2,4,6-triisopropyl-1-phenylene carbodiimide) (Stabaxol® P-100), poly(2,6-diisopropyl-1,3-phenylene carbodiimide) (Stabaxol® P), poly(tolyl carbodiimide), poly(4,4′-diphenylmethane carbodiimide), poly(3,3′-dimethyl-4,4′-biphenylene carbodiimide), poly(p-phenylene carbodiimide), poly(m-phenylene carbodiimide), poly(3,3′-dimethyl-4,4′-diphenylmethane carbodiimide), poly(naphthylenecarbodiimide), poly(isophorone carbodiimide), poly(cumene carbodiimide), p-phenylene bis(ethylcarbodiimide), 1,6-hexamethylene bis(ethylcarbodiimide), 1,8-octamethylene bis(ethylcarbodiimide), 1,10-decamethylene bis(ethylcarbodiimide), 1,12-dodecamethylene bis(ethylcarbodiimide) and mixtures thereof.

In particular, the polyester for the preparation of antifogging films according to the invention may be used in a mixture with biodegradable polyesters of the dicarboxylic acid-diol type, the hydroxy acid type or the polyester-ether type.

As far as biodegradable polyesters of the dicarboxylic acid-diol type are concerned, they may be either aliphatic or aliphatic-aromatic.

Said biodegradable aliphatic polyesters from diacid-diols comprise aliphatic dicarboxylic acids and aliphatic diols while the aromatic part of said biodegradable aliphatic-aromatic polyesters consists mainly of polyfunctional aromatic acids of both synthetic and renewable origin, while the aliphatic part consists of aliphatic dicarboxylic acids and aliphatic diols.

Said biodegradable aliphatic-aromatic polyesters from diacid-diols are preferably characterised by an aromatic acid content of between 30 and 90% by moles, preferably between 45 and 70% by moles with respect to the acid component.

Preferably the polyfunctional aromatic acids of synthetic origin are dicarboxylic aromatic compounds of the phthalic acid type and their esters, preferably terephthalic acid. The polyfunctional aromatic acids of renewable origin are preferably selected from the group comprising 2,5-furandicarboxylic acid and its esters.

Biodegradable aliphatic-aromatic polyesters from dicarboxylic acid-diols in which the aromatic diacid component consists of mixtures of polyfunctional aromatic acids of synthetic and renewable origin are particularly preferred.

The aliphatic dicarboxylic acids of biodegradable polyesters from dicarboxylic acid-diols are aliphatic dicarboxylic acids having numbers of carbon atoms in the main chain between 2 and 22 and their esters. Dicarboxylic acids from renewable sources, their esters and their mixtures are preferred; among these adipic acid, pimelic acid, suberic acid, sebacic acid, azelaic acid, undecandioic acid, dodecandioic acid, brassylic acid and their mixtures are preferred.

Examples of aliphatic diols in biodegradable polyesters from diacid-diols are: 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanedimethanol, neopentylglycol, 2-methyl-1,3-propanediol, dianhydrosorbitol, dianhydromannitol, dianhydroiditol, cyclohexanediol, cyclohexanemethanediol and mixtures thereof. Of these, 1,4-butanediol, 1,3-propanediol and 1,2-ethanediol and mixtures thereof are particularly preferred.

Preferably the polyester mixtures for preparing antifogging films according to the invention with the biodegradable polyesters from diacid-diols described above are characterised by a content of said biodegradable polyesters varying in the range 5-95% by weight, more preferably 10-90% by weight with respect to polyester i).

The polyester for preparing antifogging film according to the invention may also be mixed with more than one aliphatic-aromatic polyester having an aromatic part consisting mainly of polyfunctional aromatic acids of both synthetic and renewable origin or mixtures thereof.

With regard to the polyester mixtures for preparing antifogging films according to the invention, the preferred biodegradable polyesters from hydroxy acid include: poly L lactic acid, poly D lactic acid and poly D-L lactic acid complex stereo, poly-ε-caprolactone, polyhydroxybutyrate, polyhydroxybutyrate-valerate, polyhydroxybutyrate propanoate, polyhydroxybutyrate-hexanoate, polyhydroxybutyrate-decanoate, polyhydroxybutyrate-dodecanoate, polyhydroxybutyrate-octadecanoate, poly 3-hydroxybutyrate-4-hydroxybutyrate.

Preferably the polyester mixtures for preparing antifogging films according to the invention with the biodegradable hydroxyacid polyesters described above are characterised by a content of said biodegradable polyesters varying in the range 1-10% by weight, more preferably between 1-5% by weight with respect to polyester i).

In a particularly preferred embodiment the polyester for preparing antifogging films according to the present invention is mixed with 1-5% by weight of a polylactic acid polymer containing at least 75% L-lactic acid or D-lactic acid or combinations thereof, with a molecular weight Mw of above 30000.

Said mixtures are advantageously prepared through reactive processes for the extrusion of polyester according to the present invention with said polylactic acid polymer, preferably in the presence of organic peroxides such as those disclosed above.

The polyester may also be used in mixtures with polymers of natural origin such as starch, cellulose, chitin, chitosan, alginates, proteins such as gluten, zein, casein, collagen, gelatine, natural gums, lignins as such or purified, hydrolysed, basified, etc., lignins, or their derivatives. Starches and celluloses may be modified, including, for example, starch or cellulose esters with a level of substitution between 0.2 and 2.5, hydroxypropylated starches, modified starches with fatty chains, and cellophane. Mixtures with starch are particularly preferred. Starch may also be used in unstructured, gelatinised or filler form.

For the definition of “starch in unstructured form” according to the present invention, reference is made to the teachings in patents EP 0118240 and EP 327505 according to which starch is processed in such a way that it does not substantially show the so-called “Maltese crosses” under the optical microscope in polarised light and the so-called “ghosts” under the optical microscope in phase contrast.

The starch may constitute the continuous or dispersed phase or may be in a co-continuous form. In the case of dispersed starch, the starch is preferably in a form smaller than one μm and more preferably less than 0.5 μm in average diameter.

Preferably, the mixtures of the polyester with the polymers of natural origin described above are characterised by a content of said polymers of natural origin varying in the range of 1-30% by weight, more preferably between 2-15% by weight with respect to polyester i).

The polyester for producing films comprising anti-fogging agents according to the invention may also be used in mixtures with polyolefins, non-biodegradable polyesters, polyether-urethanes, polyurethanes, polyamides, polyamino acids, polyethers, polyureas, polycarbonates and mixtures thereof.

Preferred polyolefins are: polyethylene, polypropylene, their copolymers, polyvinyl alcohol, polyvinyl acetate, polyethyl vinyl acetate and polyethylene vinyl alcohol.

Among the non-biodegradable polyesters, PET, PBT, PTT are preferred, in particular with a renewable content >30% and polyalkylene furandicarboxylates. Among the latter, polyethylene furandicarboxylate, polypropylene furandicarboxylate, polybutylene furandicarboxylate and their mixtures are particularly preferred.

Examples of polyamides are: polyamide 6 and 6.6, polyamide 9 and 9.9, polyamide 10 and 10.10, polyamide 11 and 11.11, polyamide 12 and 12.12 and their combinations of the 6/9, 6/10, 6/11 and 6/12 type.

The polycarbonates may be polyethylene carbonates, polypropylene carbonates, polybutylene carbonates, their mixtures and copolymers.

The polyethers may be polyethylene glycols, polypropylene glycols, polybutylene glycols, their copolymers and their mixtures.

Preferably, the mixtures of polyester with the polymers described above (polyolefins, non-biodegradable polyesters, polyester- and polyether-urethanes, polyurethanes, polyamides, polyamino acids, polyethers, polyureas, polycarbonates and mixtures thereof) are characterised by a content of said polymers in the range 0.5-99% by weight, more preferably 5-50% by weight relative to polyester i).

The process for production of the polyester used to produce anti-fogging films according to the present invention may be carried out according to any of the processes known in the state of the art.

In particular, the polyester may advantageously be obtained by a polycondensation reaction. Advantageously, the polyester polymerisation process may be conducted in the presence of a suitable catalyst. As suitable catalysts, mention may be made of, by way of example, organometallic tin compounds, for example stannoic acid derivatives, titanium compounds, for example ortho-butyl titanate, aluminium compounds, for example Al-triisopropyl, or antimony and zinc compounds.

The content of terminal acid groups in the polyester used to prepare antifogging films according to the present invention is preferably less than 100 meq/kg, preferably less than 60 meq/kg and even more preferably less than 40 meq/kg.

The terminal acid groups content may be measured as follows: 1.5-3 g of the polyester is placed in a 100 ml conical flask together with 60 ml of chloroform. After complete dissolution of the polyester, 25 ml of 2-propanol and, immediately before analysis, 1 ml of deionised water are added. The resulting solution is titrated with a previously standardised solution of NaOH in ethanol. An appropriate indicator, such as a glass electrode for acid-base titration in non-aqueous solvents, is used to determine the equivalence point of the titration. The content of terminal acid groups is calculated from the consumption of NaOH solution in ethanol according to the following equation:

$$Terminal acid groups content ( meq / kg of polymer ) = \frac{⌊ ( {V}_{eq} - {V}_{b} ) \cdot T ⌋ \cdot 1000}{P}$$

where:
Veq=ml of NaOH solution in ethanol at the equivalence point of the sample titration;
Vb=ml of NaOH solution in ethanol required to achieve pH=9.5 in the blank titration;
T=concentration of NaOH solution in ethanol expressed by moles/litre;
P=weight of sample in grams.

The present invention relates to a film obtained from said biodegradable polyester comprising an anti-fogging agent and the process of making said film. Said film has properties which make it suitable for many practical applications in connection with domestic and industrial consumption. Examples of such applications are food and non-food packaging, industrial packaging (e.g. pallets), baling in agriculture, and waste wrapping.

Said film may also advantageously be produced by means of film blowing processes in which the bubble can be opened allowing reels of single layer film to be collected downstream from the film-forming process. This feature is particularly advantageous in terms of the productivity of the production process.

Preferably, the bubble-blowing film-forming process is characterised by blow-up (BUR or transverse stretch) ratios from 2 to 5, and drawdown (DDR or longitudinal stretch) ratios in the machine direction (MD) from 5 to 60. In the meaning of the present invention, DDR means a measure of the elongation of the melt exiting the extruder in the drawing direction; BUR means the ratio of the bubble diameter to die diameter. Advantageously, the process parameters are set to have a DDR/BUR ratio of 3 to 15 during bubble blowing.

Process coadjuvants may be added during the film-forming step without affecting the clingability or transparency of the adherent films according to the present invention. Such addition is performed according to processes known to those skilled in the art. The process coadjuvants are preferably fatty acid amides, such as for example stearamide, behenamide, erucamide, oleamide, ethylene bis stearamide, ethylene bis oleamide and derivatives and anti-block agents, such as for example silica, calcium carbonate, talc or kaolin.

The films according to the present invention comprising anti-fogging agents have extreme thinness characteristics in the range 3 to 50 μm. Preferably between 6 and 25 μm.

The film according to the present invention shows strong properties of adhesion, both to itself and to other non-adherent surfaces such as ceramics, glass, metal and plastics such as HDPE, LDPE, PP, PET, PVC.

Furthermore, as a result of the chemical-physical characteristics of the biodegradable polyester used, the adherent film obtained from said polyester can be produced without the use of plasticisers or adhesion agents (known as tackifiers) such as, for example, polyisobutene or ethylene vinyl acetate. This makes it possible to appreciate a further significant difference between the film according to the present invention and PVC and polyethylene adherent films which, because of the presence of the aforementioned additives, have significant limitations on use in the food packaging sector.

In a particularly preferred embodiment, the film according to the present invention is substantially free of plasticisers and adhesion agents.

The film also has excellent mechanical properties which, through a specific combination of ease of tearing, strength and stretchability, make it particularly suitable for use in industrial packaging as well as food packaging.

Preferably said film has an elongation at break >350%, elastic modulus >70 MPa and load at break >30 MPa in the transverse direction to the film-forming direction and an elongation at break >300%, elastic modulus >80 MPa and load at break >35 MPa in the longitudinal direction with respect to the film-forming direction.

More preferably said film has an elongation at break >400%, elastic modulus >90 MPa and load at break >40 MPa in the transverse direction to the film-forming direction and an elongation at break >350%, elastic modulus >100 MPa and load at break of >45 MPa in the longitudinal direction with respect to the film-forming direction.

As far as mechanical properties are concerned, in the meaning according to the present invention these are determined according to ASTM D882 (traction at 23° C. and 55% relative humidity and vₒ=50 mm/min).

The film is characterised by a maximum puncture resistance of more than 15 N, preferably more than 20 N, as determined by ASTM D5748 (Standard Test Method for Protrusion Puncture Resistance of Stretch Wrap Film).

The film is advantageously characterised by excellent optical properties. In particular, it preferably has Haze values <20%, preferably <15%, even more preferably <10% and Transmittance values greater than 80%, preferably greater than 90%, thereby enabling the user to identify an object wrapped therein without the need to unwrap the object. This characteristic is extremely advantageous when used for food packaging. Optical properties are determined in accordance with ASTM D1003.

Films with compositions including biodegradable hydroxy acid polyesters (e.g. PLA) have an increased elastic modulus, reduced clingability and improved unwindability, at the expense of transparency.

In addition to the above-mentioned characteristics, the film obtained according to the present invention advantageously has much higher water vapour permeability than PVC and PE films. In particular, it preferably has a WVTR (Water Vapour Transmission Rate) of more than 200 g/m²/day, measured at 23° C., 50% RH on a film of 16 μm thickness, preferably between 300 and 900 g/m²/day.

Water vapour permeability characteristics are determined according to ASTM F1249.

Biodegradable packaging film according to the present invention means a biodegradable and compostable film according to standard EN 13432.

The film anti-fogging agents according to the invention are compounds which, like soaps and emulsifiers, consist of molecules having a polar part and a non-polar part. In the molecule, the non-polar part generally adheres to the film while the polar radicals bring about increased polarity on the surface of the film. This has the effect of diffusing the water droplets, which appear as an additional layer of water on the film, and moving them away. It is therefore particularly surprising that this additional layer of antifogging agent has such an effect on the film to increase transparency (particularly Haze) compared to the same film produced by the same biodegradable polyesters but without antifogging agent.

A further surprising effect, which overturns a prejudice in the art, is that the films according to the invention in which an antifogging agent is present exhibit excellent behaviour in packaging machines.

In particular, it has been confirmed that present-day wrapping machines can pack up to 80-90 packs per minute with the film according to the present invention. As regards the mechanical characteristics under natural ageing conditions, the film still manifests good toughness six months after the film-forming process.

In particular, with regard to mechanical characteristics under natural ageing conditions, six months after the film-forming process the film suffers a fall of no more than 35%, and preferably no more than 25%, in load at break (determined according to ASTM D882 at 23° C. and 55% relative humidity and vₒ=50 mm/min) and perforation resistance of the stretch film under biaxial stress (expressed as the force at break (N) and determined according to ASTM D5748 at 23° C. and 55% relative humidity and vₒ=250 mm/min) The films according to the present invention are particularly suitable for packaging foodstuffs, for industrial packaging, for bale compression in agriculture, and for wrapping waste.

### EXAMPLES

### Example 1—Preparation of Biodegradable Polyesters, Description of the Antifogging Agents Used and Table of Compositions Used

P1: Poly(1,4-butylene adipate-co-1,4-butylene terephthalate) [PBAT], with a terephthalic acid content of 47% by moles with respect to the total dicarboxylic component. PBAT has an MFR of 4.1 g/10 min (@ 190° C., 2.16 kg), a shear viscosity of 1304 Pas at 180° C., a melt strength of 1.0 g and a terminal acid group content of 38 meq/kg.

P2: Poly(1,4-butylene adipate-co-1,4-butylene azelate-co-1,4-butylene terephthalate) [PBATAz], having a terephthalic acid content of 47% by moles with respect to the total dicarboxylic component. PBATAz has an MFR of 4.9 g/10 min (@ 190° C., 2.16 kg), a shear viscosity of 1178 Pas at 180° C., a melt strength of 1.1 g and a terminal acid group content of 34 meq/kg. PLA: Ingeo 3251D polylactic acid characterised by an MFR of 35 g/10 min (@ 190° C., 2.16 kg) and M_{W}=105000.

P3: Poly(1,4-butylene adipate-co-1,4-butylene terephthalate) [PBAT], with a terephthalic acid content of 47% by moles with respect to the total dicarboxylic component. PBAT has an MFR of 4.2 g/10 min (@ 190° C., 2.16 kg), a shear viscosity of 1289 Pas at 180° C., a melt strength of 0.9 g and a terminal acid group content of 33 meq/kg.

A1: polyglycerol laurate antifogging agent manufactured by Sabo©

A2: sorbitan polyoxyethylene monolaurate ester manufactured by Croda©

AC: sorbitan monostearate antifogging agent manufactured by Sabo©

S: HMV-5CA-LC hydrolysis stabiliser

TABLE 1
Compositions.

| Composition | P1 | P2 | P3 | PLA | A1 | A2 | AC | S |
|---|---|---|---|---|---|---|---|---|
| 1 | 98.3 | — | — | — | 1.5 | — | — | 0.2 |
| 2 | 98.8 | — | — | — | 1.0 | — | — | 0.2 |
| 3 | — | 98.5 | — | — | 1.5 | — | — | — |
| 4 (comparison) | 99.8 | — | — | — | — | — | — | 0.2 |
| 5 (comparison) | — | 100 | — | — | — | — | — | — |
| 6 (comparison) | 98.8 | — | — | — | — | — | 1.0 | 0.2 |
| 7 | 95.3 | — | — | 3,0 | 1.5 | — | — | 0.2 |
| 8 | 95.8 | — | — | 3,0 | 1.0 | — | — | 0.2 |
| 9 (comparison) | 96.8 | — | — | 3,0 | — | — | — | 0.2 |
| 10 | — | — | 98.4 | — | — | 1.5 | — | 0.1 |

The different compositions were fed to a model OMC EBV60/36 twin-screw extruder operating under the following conditions:
Screw diameter (D)=58 mm;
L/D=36;
Screw rotation=140 rpm;
Temperature profile=60-150-180-190×4-150×2° C.;
Throughput: 40 kg/h;
Vacuum degassing in zone 8 out of 10

The granules thus obtained were fed to a Ghioldi model blown film machine with a 40 mm screw diameter and L/D 30 operating at 30 rpm. The film-forming head had an air gap of 0.9 mm and L/D 12. Films of 18 μm thickness (9+9) [examples 1, 2, 4, 6-10] and 20 μm thickness (10+10) [examples 3, 5] were obtained using the conditions described in Table 2:

TABLE 2
Operating conditions used during film-forming.

| | Film temperature | Blowing ratio | Drawdown ratio |
|---|---|---|---|
| Composition | (° C.) | (BBR) | (DDR) |
| 1 | 145 | 3.2 | 31.7 |
| 2 | 145 | 3.2 | 31.7 |
| 3 | 145 | 3.2 | 28.5 |
| 4 (comparison) | 145 | 3.2 | 31.7 |
| 5 (comparison) | 145 | 3.2 | 28.5 |
| 6 (comparison) | 145 | 3.2 | 31.7 |
| 7 | 170 | 3.2 | 31.7 |
| 8 | 170 | 3.2 | 31.7 |
| 9 (comparison) | 170 | 3.2 | 31.7 |
| 10 | 170 | 3.2 | 31.7 |

3 grams of film were analysed to determine the weight percentage of polyester oligomer (“q”) having a mean molecular weight of GPC≤10000 using the method described in the text. The films were analysed by gel permeation chromatography (GPC). Measurements were made at 40° C. using an Agilent® 1100 chromatograph. The determination was made using a set of two columns in series (particle diameters of 5 μm and 3 μm with mixed porosity), a refractive index detector, chloroform as eluent (flow rate 0.5 ml/min) and using polystyrene as reference standard.

TABLE 3
Physical and chemical characteristics of the prepared films.

| | Oligomer | | | |
|---|---|---|---|---|
| Composition | content (“q”) | Mn | Mw | Mw/q |
| 1 | 1.54 | 68720 | 128190 | 83240 |
| 2 | 1.55 | 68514 | 128446 | 82969 |
| 3 | 1.81 | 59605 | 115970 | 64072 |
| 4 (comparison) | 1.60 | 68308 | 127164 | 79478 |
| 5 (comparison) | 1.71 | 60933 | 126620 | 74047 |
| 6 (comparison) | 1.55 | 68445 | 128434 | 82860 |
| 7 | 2.41 | 63884 | 125580 | 52108 |
| 8 | 2.42 | 63820 | 125329 | 51789 |
| 9 (comparison) | 2.45 | 63628 | 124701 | 50898 |
| 10 | 1.52 | 69475 | 120080 | 79000 |

Mechanical properties were determined according to ASTM D882 (Tensile strength at 230° C. and 55% relative humidity and vₒ=50 mm/min).

Optical properties were determined according to ASTM D1003.

Water vapour permeability was determined at 23° C. and 50% relative humidity using ASTM F1249.

Cold Fog tests were performed to evaluate anti-fogging agent performance. 200 ml of water at a temperature of 30° C. was poured into a 250 ml beaker. The film under test was attached to the beaker and the sample was then placed in a refrigerator at 4° C. The change in the surface of the film in terms of water layer formation was recorded, and observations were made removing the beaker from the refrigerator after 5 min, 15 min, 30 min, 1 hour, 2 hours, 3 hours, 4 hours, 5 hours, 6 hours, 1 day, 2 days, 3 days, 4 days and 6 days. As an indicator of the effect of the anti-fogging agent, reference is made to the moment when the transition from a layer of drops to a discontinuous film of water takes place.

### Example 2 Comparison of Experimental Data

TABLE 4
Comparison of clingability and transparency.

| | Anti- | | | Trans- | | |
|---|---|---|---|---|---|---|
| Compo- | fogging | cling- | unwind- | mittance | Haze | Clarity |
| sition | effect | ability | ability | (%) | (%) | (%) |
| 1 | 30 min | 5 | 5 | 92 | 5 | 99 |
| 2 | 60 min | 4 | 4 | 92 | 6 | 98 |
| 3 | 30 min | 5 | 5 | 92 | 5 | 99 |
| 4 (com- | Not found | 4 | 2 | 92 | 7 | 99 |
| parison) | | | | | | |
| 5 (com- | Not found | 4 | 2 | 92 | 6 | 98 |
| parison) | | | | | | |
| 6 (com- | Not found | 1 | 5 | 91 | 12 | 97 |
| parison) | | | | | | |
| 10 | 30 min | 5 | 4 | 92 | 4 | 99 |

Key to Table 4: The term “clingability” according to the present invention defines the ability of the film to adhere to itself and to a surface on a scale from 1 (little) to 5 (much). The term “unwindability” according to the present invention is understood as ease of unwinding the film on a scale from 1 (little) to 5 (much).

TABLE 5
Comparison of clingability and transparency.

| | Anti- | | | Trans- | | |
|---|---|---|---|---|---|---|
| | fogging | cling- | unwind- | mittance | Haze | Clarity |
| Composition | effect | ability | ability | (%) | (%) | (%) |
| 7 | 30 min | 4 | 5 | 92 | 14 | 98 |
| 8 | 60 min | 3 | 5 | 92 | 15 | 97 |
| 9 (com- | Not found | 2 | 4 | 92 | 15 | 95 |
| parison) | | | | | | |

Key Table 5: The term “clingability” according to the present invention defines the ability of the film to adhere to itself and to a surface on a scale from 1 (little) to 5 (much). The term “unwindability” according to the present invention is understood as ease of unwinding the film on a scale from 1 (little) to 5 (much).

TABLE 6
Mechanical properties and water vapour permeability of film
with the anti-fogging agent according to the invention.

| | | Load | Elongation | Elastic | |
|---|---|---|---|---|---|
| | | at break | at break | modulus | WVTR |
| Composition | Dir. | (MPa) | (%) | (MPa) | (g/m²/day) |
| 1 | MD | 56 | 354 | 98 | 310 |
| | TD | 48 | 693 | 118 | |
| 2 | MD | 58 | 347 | 102 | 328 |
| | TD | 46 | 704 | 122 | |
| 3 | MD | 45 | 378 | 97 | 315 |
| | TD | 43 | 698 | 115 | |
| 4 (comparison) | MD | 59 | 382 | 119 | 396 |
| | TD | 66 | 526 | 115 | |
| 5 (comparison) | MD | 47 | 386 | 93 | 385 |
| | TD | 54 | 518 | 108 | |
| 6 (comparison) | MD | 55 | 338 | 111 | 170 |
| | TD | 46 | 582 | 125 | |
| 10 | MD | 54 | 309 | 115 | 313 |
| | TD | 43 | 588 | 125 | |

As can be seen, the high water vapour barrier in comparison example 6 (WVTR=170 g/m²/day) confirms that excessive migration of the anti-fogging agent to the surface does not confer any anti-fogging properties and results in a deterioration in optical properties compared to the reference.

TABLE 7
Mechanical properties and water vapour permeability of film
with the anti-fogging agent according to the invention.

| | | Load | Elongation | Elastic | |
|---|---|---|---|---|---|
| | | at break | at break | modulus | WVTR |
| Composition | Dir. | (MPa) | (%) | (MPa) | (g/m2day) |
| 7 | MD | 43 | 406 | 179 | 330 |
| | TD | 49 | 648 | 117 | |
| 8 | MD | 45 | 400 | 173 | 338 |
| | TD | 51 | 615 | 120 | |
| 9 (comparison) | MD | 48 | 347 | 223 | 387 |
| | TD | 52 | 487 | 146 | |

### Example 3 Film Performance in Food Tray Packaging Equipment

The film prepared according to example 1 (composition 1) was tested using the STN 8500WE © food tray packaging machine from OMORI.

The film had a nominal thickness of 16-18 micron—reel strip 400 mm; the tray used was PS with a short side circumference of 360 mm.

The packaging phase was divided into three stages:
1. Wrapping tray, central welding and tube cutting;
2. Folding head and tail flaps of the tube under the tray;
3. Transport on heated belt and flap welding.

In the first phase the film showed good machine behaviour both in the transport and conveying phase (excellent elasticity) and sealing of the central zone, which is performed by two pairs of heated rollers (set at 135° C.). No critical points were noted even in the cutting stage.

In the second phase, regular folding of the flap at the bottom of the tray brought about by running at a high packaging speed, increasing from 35 to 80-90 trays/min, with a glass fibre belt temperature set at 150° C.

No significant criticalities were identified during the stage of transport on the heated belt and welding (third phase).

1. A packaging film with a coefficient of static friction (COF) >5 comprising:
(i) a biodegradable polyester having a melt strength of 0.7-4 g and comprising units of at least one dicarboxylic acid and at least one diol and having:
Mn≥40000
Mw/q≤90000,
where melt strength is measured according to ISO 16790:2005 at 180° C. and γ=103.7 s⁻¹ using a capillary of 1 mm diameter and L/D=30 at a constant acceleration of 6 mm/sec² and a stretching length of 110 mm; the molecular weights “Mn” and “Mw” are measured by gel permeation chromatography (GPC); “q”=the percentage by weight of polyester oligomer having a molecular weight by GPC≤10000 and
(ii) an anti-fogging agent selected from an ester of a polyfunctional alcohol, provided that the ester is not a stearate.

2. The packaging film according to claim 1 for the production of thin films of thickness 3-50 μm.

3. The packaging film according to claim 1, in which said anti-fogging agent is in a quantity of 0.2-5 relative to the polyester content.

4. The packaging film according to claim 1, in which said anti-fogging agent is in a quantity of 1.0-2.0% relative to the polyester content.

5. The packaging film according to claim 1, in which said anti-fogging agent is selected from an ester of a fatty acid having 8 to 18 carbon atoms.

6. The packaging film according to claim 1, in which said anti-fogging agent is selected from polyglyceryl laurate and sorbitan monolaurate.

7. The packaging film according to claim 1, in which said anti-fogging agent is sorbitan polyoxyethylene monolaurate ester.

8. The packaging film according to claim 1, in which said anti-fogging agent is added to the polyester either by an extrusion process directly as the desired final concentration, or in a hopper during the film-forming step in the form of a “masterbatch”.

9. The packaging film according to claim 1, in which the biodegradable polyester i) has an aromatic moiety comprising at least one polyfunctional aromatic acid and an aliphatic moiety comprising at least one aliphatic diacid and at least one aliphatic diol.

10. The packaging film according to claim 1, in which the biodegradable polyester i) comprises a biodegradable aliphatic-aromatic polyester and an aliphatic polyester.

11. The packaging film according to claim 9, in which the polyfunctional aromatic acids are selected from aromatic dicarboxylic compounds of the phthalic acid type and heterocyclic aromatic dicarboxylic compounds of renewable origin, esters thereof and mixtures thereof.

12. The packaging film according to claim 1, in which in said biodegradable polyester i) said dicarboxylic acid comprises at least 50% by moles of an acid selected from azelaic acid, sebacic acid, adipic acid or mixtures thereof with respect to the total moles of aliphatic dicarboxylic acid.

13. The packaging film according to claim 1, in which the biodegradable polyester i) is mixed with one or more polymers of synthetic or natural origin.

14. The packaging film according to claim 13, in which said polymer of synthetic or natural origin is biodegradable.

15. The packaging film according to claim 13, in which said biodegradable polyester i) is mixed with at least one member selected from the group of poly L lactic acid, poly D lactic acid and poly D-L lactic acid complex stereo, poly-ε-caprolactone, poly hydroxybutyrate, poly hydroxybutyrate-valerate, polyhydroxybutyrate-propanoate, polyhydroxybutyrate-hexanoate, polyhydroxybutyrate-decanoate, polyhydroxybutyrate-dodecanoate, polyhydroxybutyrate-octadecanoate, and poly 3-hydroxybutyrate-4-hydroxybutyrate.

16. The packaging film according to claim 13, in which the biodegradable polyester i) is mixed with 1-5% by weight of a polylactic acid polymer containing at least 75% L-lactic acid or D-lactic acid or combinations thereof, with a molecular weight Mw of over 30000.

17. The packaging film according to claim 1 for packaging of food articles, for industrial packaging, for bale compression in agriculture, or for wrapping waste.

18. A method for producing thin films having a coefficient of static friction (COF) >5 and a thickness of 3-50 μm which comprises admixing an anti-fogging agent selected from esters of a polyfunctional alcohol, with the proviso that said ester is not a stearate, with a biodegradable polyester having a melt strength of 0.7-4 g and comprising units of at least one dicarboxylic acid and at least one diol and having:
Mn≥40000
Mw/q≤90000,
where melt strength is measured according to ISO 16790:2005 at 180° C. and γ=103.7 s⁻¹ using a capillary of 1 mm diameter and L/D=30 at a constant acceleration of 6 mm/sec² and a stretching length of 110 mm; the molecular weights “Mn” and “Mw” are measured by gel permeation chromatography (GPC); “q”=the percentage by weight of polyester oligomer having a molecular weight by GPC≤10000.

19. The packaging film according to claim 2, in which the biodegradable polyester i) has an aromatic moiety comprising at least one polyfunctional aromatic acid and an aliphatic moiety comprising at least one aliphatic diacid and at least one aliphatic diol.

20. The packaging film according to claim 3, in which the biodegradable polyester i) has an aromatic moiety comprising at least one polyfunctional aromatic acid and an aliphatic moiety comprising at least one aliphatic diacid and at least one aliphatic diol.
